(19) United States
(12) Patent Application Publication
(10) Pub. No.: US 2015/0278873 A1
(43) Pub. Date: Oct. 1, 2015

(54) LOCAL ADVERTISEMENT VIA MOBILE DEVICE

(71) Applicant: Richard S. Sylvester, Asheville, NC (US)

(72) Inventor: Richard S. Sylvester, Asheville, NC (US)

(21) Appl. No.: 14/663,488

(22) Filed: Mar. 20, 2015

Related U.S. Application Data
(60) Provisional application No. 61/969,868, filed on Mar. 25, 2014.

(51) Int. Cl. G06Q 30/02; H04L 29/12; H04W 4/02; H04W 76/02

(52) U.S. Cl. CPC G06Q 30/0267; H04W 76/021; H04L 61/6022; H04W 4/02; G06Q 30/0261; H04W 88/08

(57) ABSTRACT

A system (or method) for sending an advertisement to a mobile communication device, across a wireless communication system, as the device passes close to or in to an advertiser having a wireless access point (AP) with a media access control (MAC) address. The system (or method) includes: a mobile application residing on the mobile communication device, and a stationary application located remotely from the mobile application. The mobile application and the stationary application communicate via the wireless communication system. The mobile application captures the MAC address of the advertiser's AP. The captured MAC address is compared to a pre-existing list of MAC addresses. If there is a no match, then no advertisement is sent to the mobile application. But, if there is a match, then the advertisement is sent to the mobile application where the advertisement is displayed.

### RELATED APPLICATION

This application claims the benefit of co-pending application Ser. No. 61/969,868 filed Mar. 25, 2014, incorporated herein by reference.

### FIELD OF THE INVENTION

The invention is directed to a system and method for local advertising to mobile devices.

### BACKGROUND OF THE INVENTION

With the widespread adoption of mobile devices connected to the worldwide web, for example, smart phones, watches, tablets, and laptops, many are looking at ways that these mobile devices can be used to advertise products and services.

One goal is to have the mobile device relay information about a merchant to the user as the user passes by (or in the proximity of or in to) a merchant or an advertiser (both will be used interchangeability hereinafter). This requires the mobile device, via an application, to know where the mobile device is both geographically and temporally. The geographical and temporal information could then be compared to information about the merchant, and then relevant information, for example, an advertisement, can be relayed to the user via the mobile device. This would allow the merchant to push an advertisement, relevant both geographically and temporarily, to the user as they pass close to or in the merchant.

There are several companies that offer applications that attempt to reach this goal, but they generally cannot pinpoint locations, instead these applications concentrate on larger geographical regions. For example, FOURSQUARE offers users the capability to look up nearby locations based on their interests. These locations can then offer paid ads to entice users to come to their location. GOOGLE-ADWORDS is geared to image/banner based advertising. ADWORDS lets the advertiser place advertisements on the top/side/bottom of a search results page, as well as, on other places, such as GOOGLE Maps. ADWORDS may be geo-specific, but the minimum area is defined by a one mile unit. GOOGLE-ADMOB is geared toward mobile advertising, and is similar to ADWORDS, but it is only city specific. TAPJOY is geared to mobile advertising, but it to is only city specific. None of these offerings allow a merchant to identify a consumer, with a mobile device, that is passing by their store and push advertisements onto the mobile device.

Some have proposed that a solution to the goal would be to use GPS, WiFi triangulation, and/or cell tower triangulation. These methods allow for good geographical and temporal location. But, with GPS, the time and battery demands make this method impractical, and with WiFi triangulation and cell tower triangulation, the locating speed is quicker and the battery demand is less, but the accuracy is not as good as GPS.

Accordingly, there is a need for a system or method whereby a merchant can identify a consumer, with a mobile device, as the consumer passes by (or in close proximity to or in to) the merchant, and push an advertisement, relevant both geographically and temporally, to the user's mobile device as the user passes by (or in close proximity to or in to) the merchant.

### SUMMARY OF THE INVENTION

In one embodiment, A system (or method) for sending an advertisement to a mobile communication device, across a wireless communication system, as the device passes close to or in to an advertiser having a wireless access point (AP) with a media access control (MAC) address. The system (or method) includes: a mobile application residing on the mobile communication device, and a stationary application located remotely from the mobile application. The mobile application and the stationary application communicate via the wireless communication system. The mobile application captures the MAC address of the advertiser's AP. The captured MAC address is compared to a pre-existing list of MAC addresses. If there is a no match, then no advertisement is sent to the mobile application. But, if there is a match, then the advertisement is sent to the mobile application where the advertisement is displayed.

### DESCRIPTION OF THE DRAWINGS

For the purpose of illustrating the invention, there is shown in the drawings a form that is presently preferred; it being understood, however, that this invention is not limited to the precise arrangements and instrumentalities shown.

FIG. 1 is a schematic illustration of an embodiment of the inventive system.

FIG. 2 is a schematic illustration of an embodiment of the capture of a MAC address.

FIG. 3 is a schematic illustration of an embodiment of determining proximity.

FIG. 4 is another schematic illustration of another embodiment of determining proximity.

FIG. 5 is a schematic illustration of another embodiment of determining proximity as a function of machine time.

FIG. 6 is a schematic illustration of another embodiment of determining proximity as a function of machine time.

FIG. 7 is a schematic illustration of another embodiment of determining proximity as a function of machine time.

FIG. 8 shows a flow chart illustrating an embodiment of the populating of MACᵢ (or APᵢ) information.

FIGS. 9A and 9B are flow charts illustrating Examples 1 and 2 respectively

FIG. 10 is a flow chart illustrating Example 3.

FIGS. 11A and 11B are flow charts illustrating Examples 4 and 5.

### DESCRIPTION OF THE INVENTION

To simplify the following description, the invention will be discussed in terms of a specific embodiment. It being understood that the invention is not so limited, but may be used with other equipment and/or other protocols, or in other configurations. Thus, hereinafter, store (or place) Sᵢ may refer to a retail store or restaurant or the like; wireless access point APᵢ may refer to any type of wireless device used to provide internet access using Wi-Fi, Bluetooth, or related standards; a media access control address MACᵢ may refer to any unique identifier associated with the APᵢ; mobile device P may refer to a cell phone, tablet, laptop, watch, or the like; wireless network may refer to a cell phone network, Wi-Fi network, or the like.

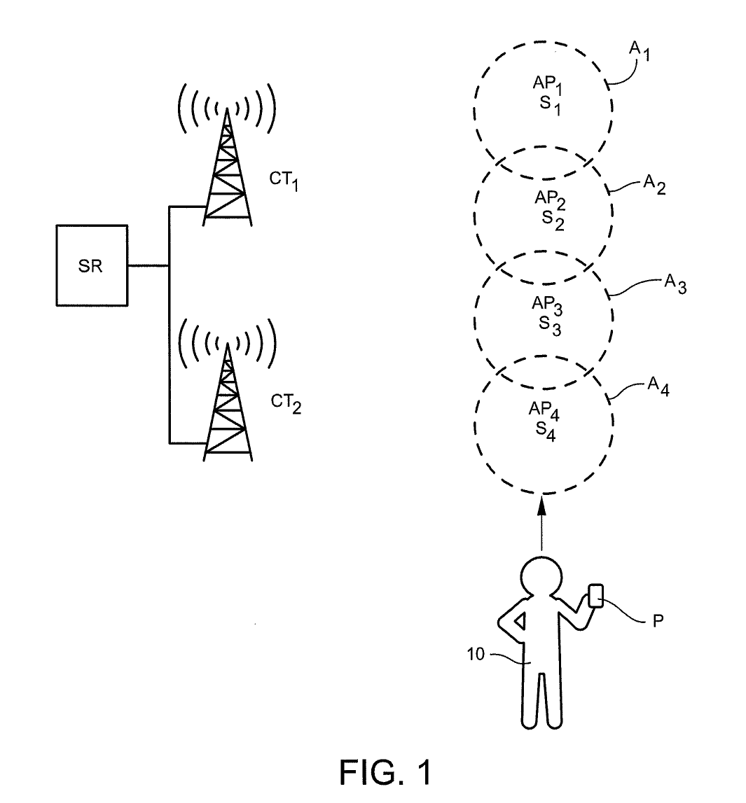

Referring to FIG. 1, there is a general schematic illustration of one embodiment of the instant invention. There are a series of stores Sᵢ. Each store has a wireless access point APᵢ. Each wireless access point APᵢ has a unique identifier MACᵢ and has a limited area Aᵢ for communication defined by the signal strength of the APᵢ.

An individual 10 has a mobile device P. Mobile device P includes a mobile application, part of the instant invention. As the individual 10 walks through an area Aᵢ, the mobile application captures the MACᵢ of the store Sᵢ. The mobile device may not have to (or does not have to) establish a communication link with the relevant APᵢ. The mobile application may be a stand-alone application or a part of another application.

The captured MACᵢ is compared against a list of pre-registered MAC addresses. The pre-registered lists of MAC addresses may reside in the mobile application on the mobile device P, or the stationary application, part of the instant invention, located remotely from the mobile device P (e.g., on a server SR in communication with the mobile application via a wireless network (e.g., cell towers CTᵢ)), or both.

Based on the comparison of the captured MACᵢ to the pre-registered MAC addresses: 1) If there is no match, no message (e.g., advertisement) is displayed on the mobile device P; 2) however, if there is a match, then the stationary application may send, via the wireless network, a message (e.g., advertisement) to the mobile application for display on the mobile device P. The display may be immediate or instantaneous of the message, or the message may be delayed. In the delay situation, the display is held up awaiting the satisfaction of some other condition. Send the message may mean send the message after the match or send the message before the match. In the latter, the system could anticipate the need to send based on, for example, proximity of the device to the APᵢ. In this case, the message could be stored, for example, in the mobile application.

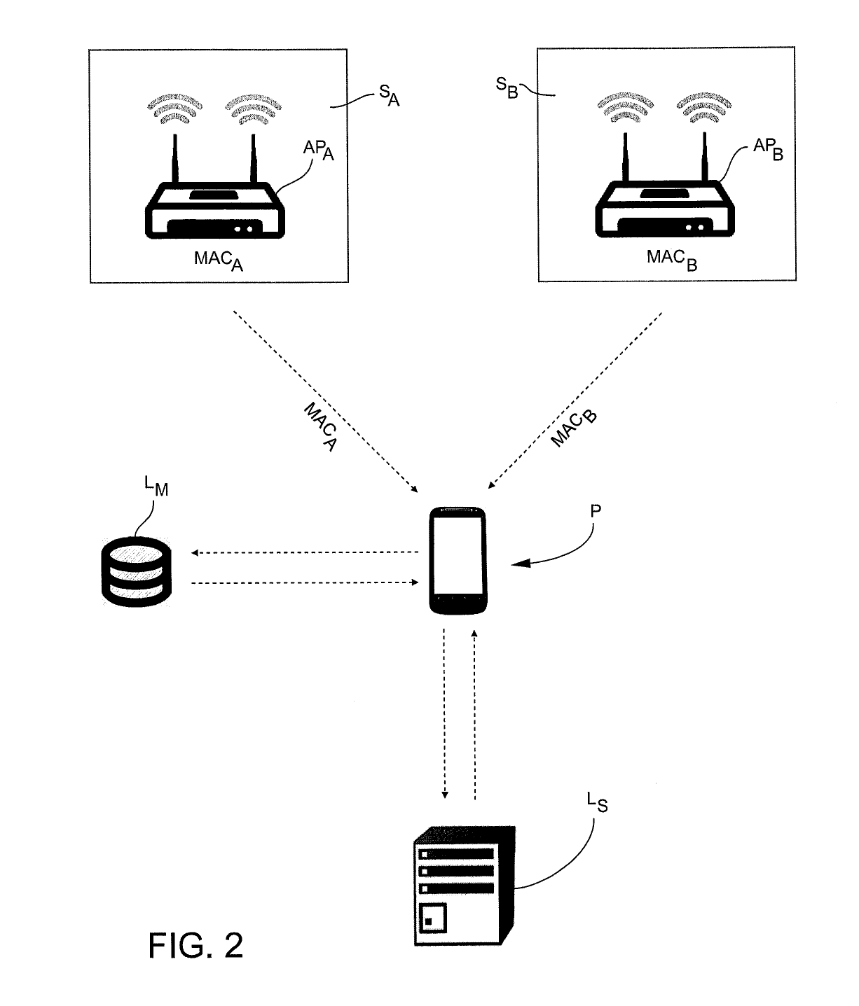

Referring to FIG. 2, the capture of the MACᵢ by the mobile device P and comparison of the captured MACᵢ address to the pre-registered MAC is illustrated. Mobile device P scans for available MACᵢ addresses. Any captured MAC addresses are compared with pre-registered MAC addresses. The pre-registered MAC addresses may reside in the mobile application Lₘ, or in the stationary application Lₛ, or both. MAC addresses residing in the mobile application may be obtained from the stationary application by a pre-fetch request based upon the general location of the mobile device. In this situation, the mobile application may use any methodology to determine a general position, for example, global positioning system (GPS), or cell phone triangulation, or the like, and then request, from the stationary application, pre-registered MAC addresses in the general area of the mobile device to populate the pre-fetch list residing in the mobile device. This list may be refreshed periodically, as the mobile device moves about. In one embodiment, the comparison begins with the pre-fetch list and then moves to the broader list in the stationary application.

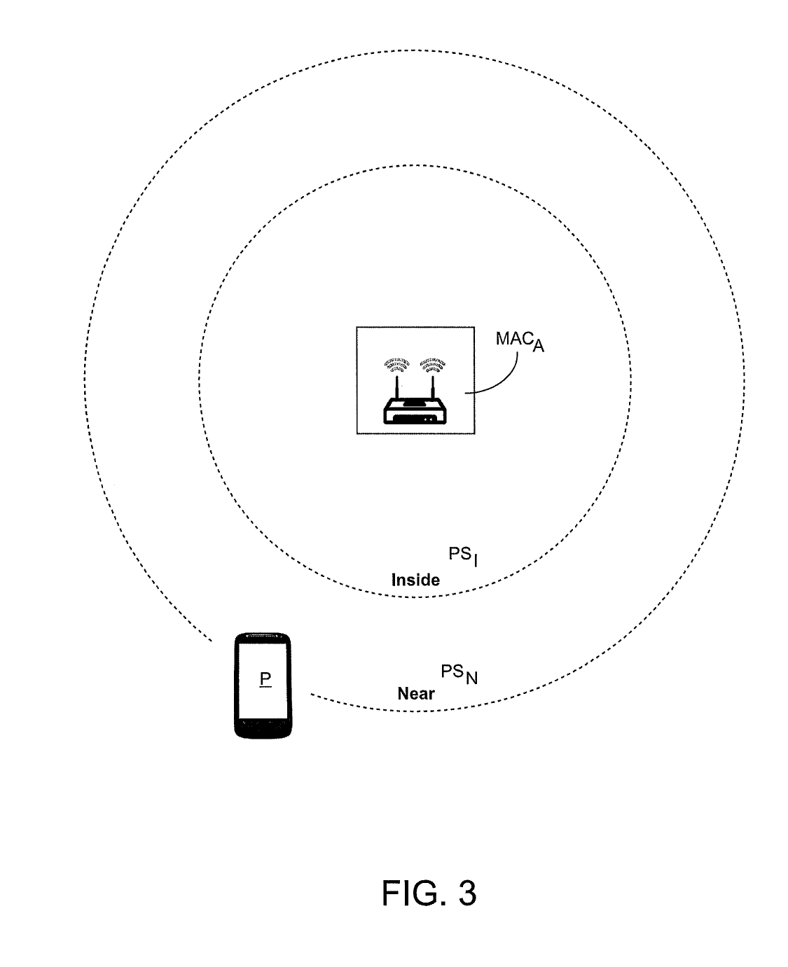

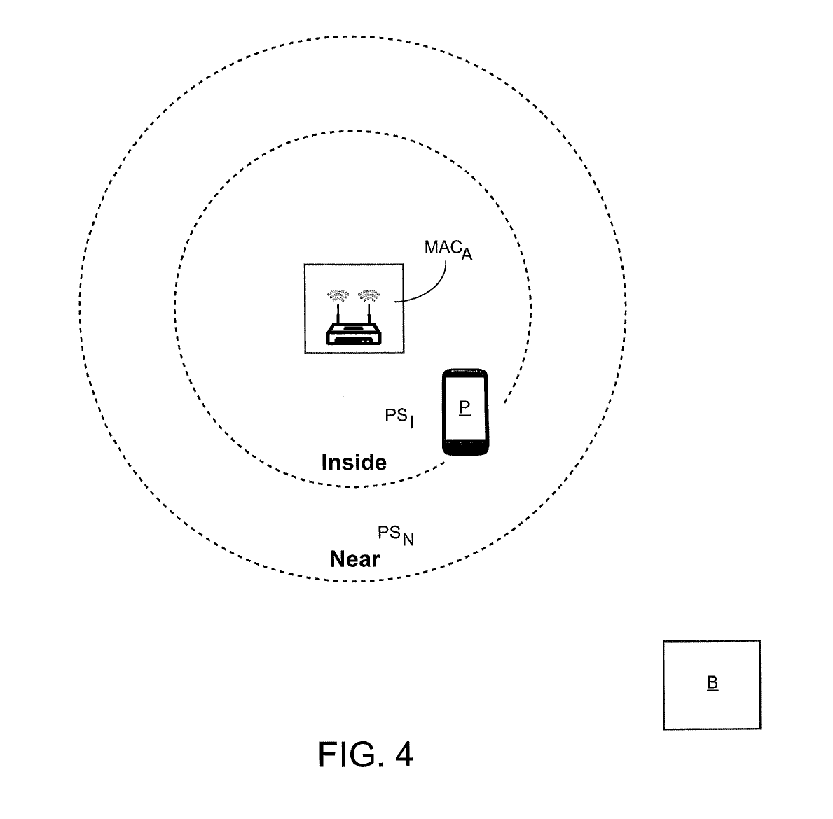

Referring to FIGS. 3 and 4, an enhancement is illustrated. In this enhancement, the proximity (location) of the mobile device P to the APᵢ may be determined. The proximity may also be referred to a place state, PSᵢ. AP_{A} with MAC_{A} has an inside region (inner area) and a near region (outer ring). There may be multiple place states defined around a APᵢ. For example, the inner region PS, may be defined as within the store S_{A}, and the near region PS_{N} may be on the sidewalk or parking lot or another store adjacent to S_{A}. These regions may be determined by signal strength from AP_{A}. Signal strength may be measured in decibel (dBm) or a calculated percentage of dBm. As an example, one may define the inside region as having good to high signal strength (e.g., ≧−65 dBm), and the near region having poor to low signal strength (e.g., <−65 dBm). FIG. 3 illustrates the mobile device P in the near region PS_{N}. FIG. 4 illustrates mobile device P is in the inside region PSᵢ.

While proximity (or place state) may be determined by signal strength of the store's APᵢ it is not so limited. In FIG. 4, the location of place B may be inferred by the signal strength from AP_{A}. For example, place B has no APᵢ, but place B is located close to AP_{A}. Thus, based upon the signal strength from AP_{A}, one may infer proximity to place B.

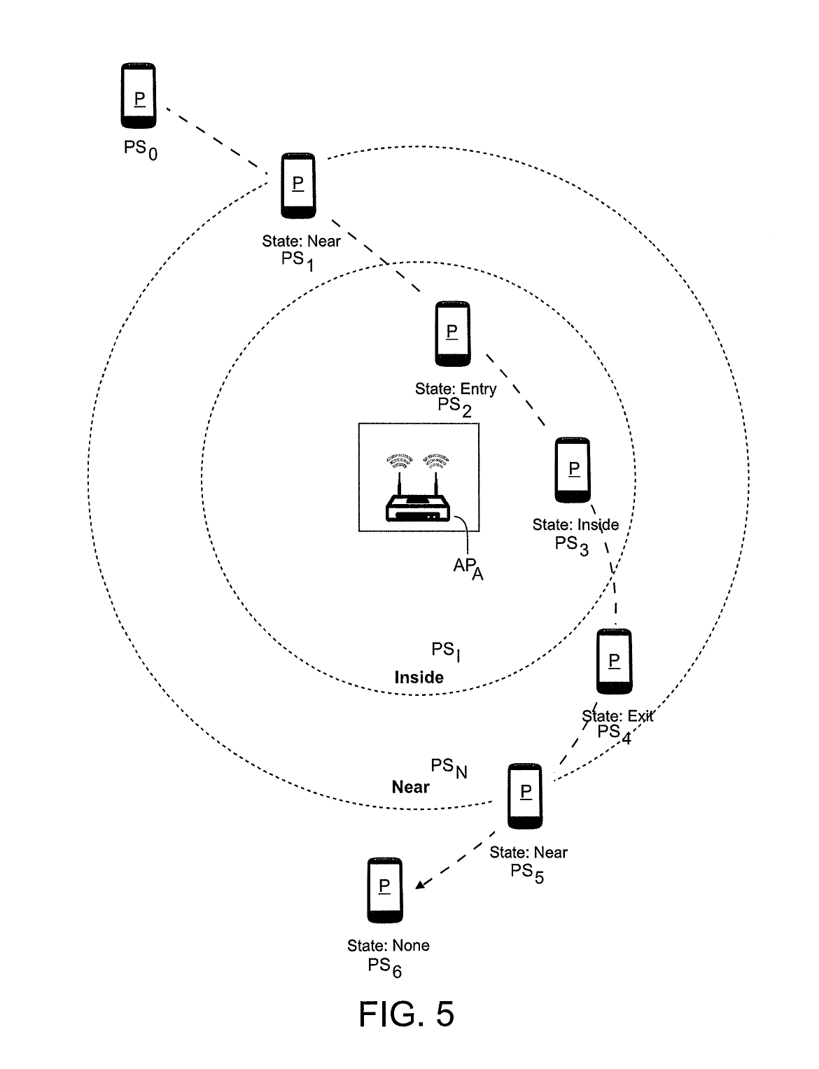

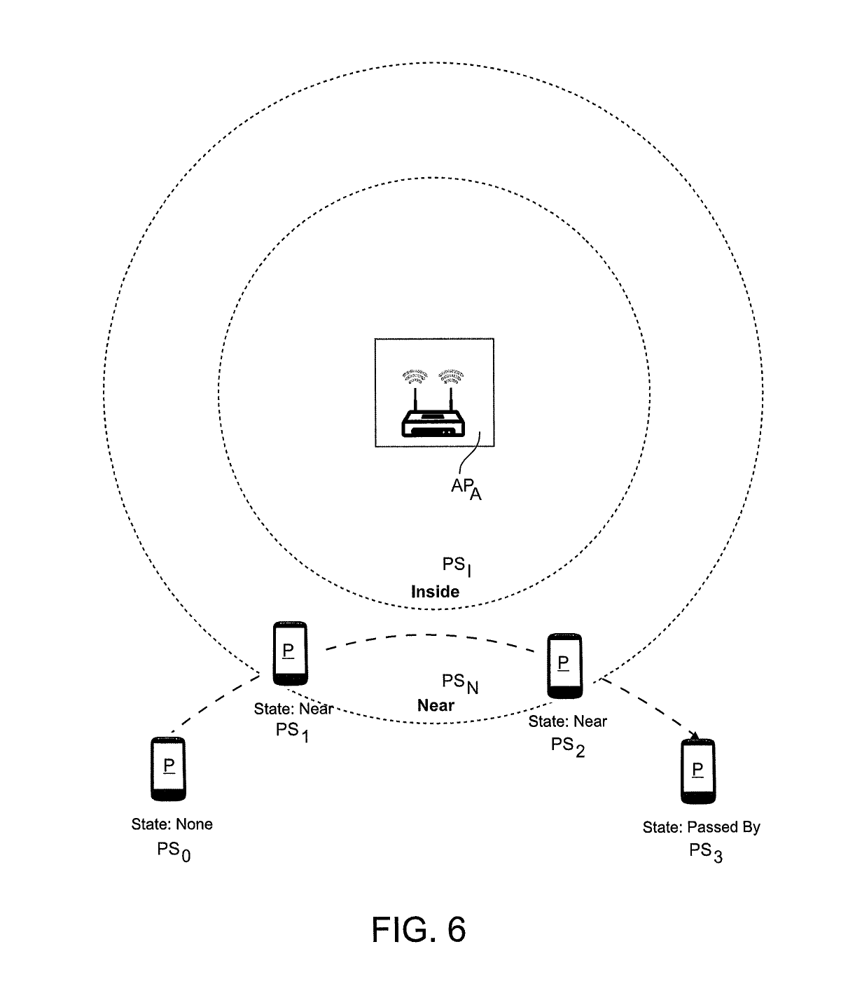

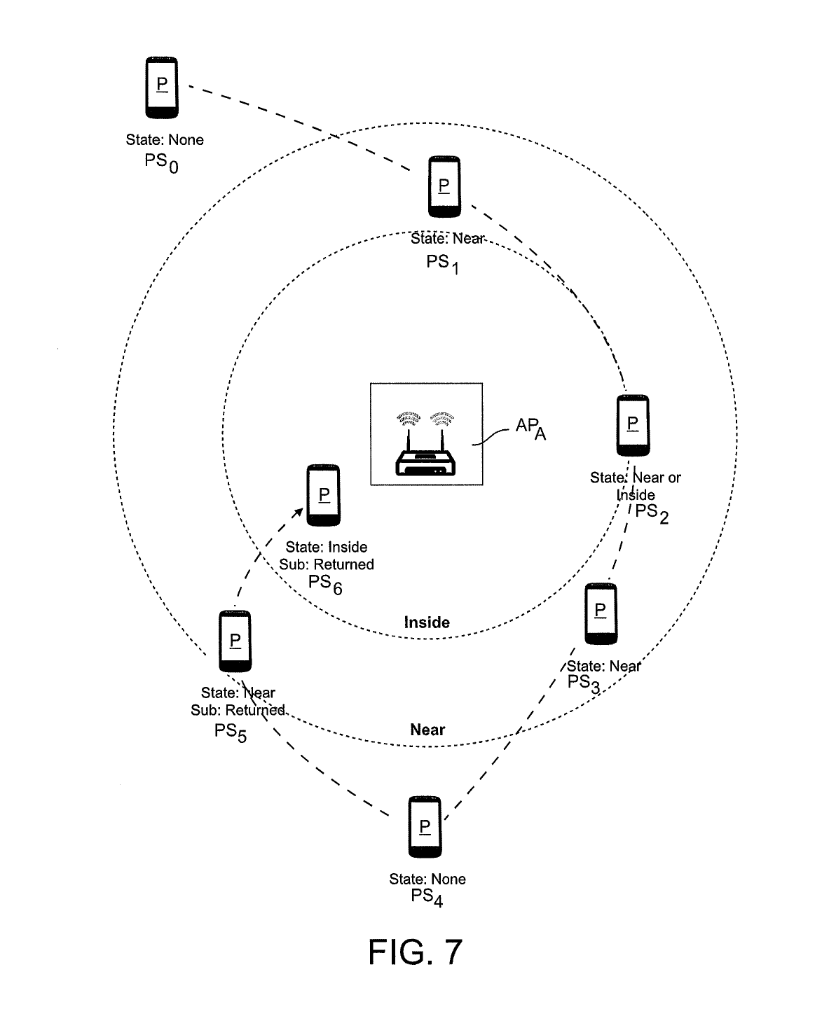

Referring to FIGS. 5-8, yet another enhancement is illustrated. In this enhancement, the proximity (or place state) is mapped as a function of a machine time. Machine time refers to a start time and finish time as generated by an internal timer within the application or using the timer of the mobile device. In this enhancement, it should be understood that place state may be as simple as the location of the mobile device and continuing to a series of device locations as a function of the machine time. For example, in FIGS. 5-7, the device P moves through a series of locations as a function of time. In FIG. 5, the device P “moves through” the store; the device P begins outside (no signal) PS₀, then moves to a near region PS₁, to an entry region PS₂, to an inside region PS₃, to an exit region PS₄, to another near region PS₅, and then to another outside region (no signal) PS₆. In FIG. 6, the device P “passes by” the store; the device begins outside (no signal) PS₀, to a first near region PS₁, to a second near region PS₂, and then outside (no signal) PS₃. In FIG. 7, the device P “moves through and returns;” the device moves from PS₀ (no signal) to PS₁ to PS₂ to PS₃ to PS₄ to PS₅ to PS₆.

Mapping the proximity (place state) as a function of time may be performed is any manner. For example, in one method is illustrated by reference to Tables 1-3:

TABLE 1

| Place State | Figure | Formula |
|---|---|---|
| Near | 3, 4 | SS < −65 dBm |
| Entry | 5 | SS >= −65 dBm && D >= 10 s && (CS != |
| | | Inside) && (! RS[Entry]) |
| Inside | 4 | SS >= −65 dBm && D >= 10 s && (CS == |
| | | Entry) |
| Exit | 5 | SS < (−65 dBm \|\| null) && ((CS == Inside) \|\| |
| | | (CS == Entry)) |
| Passed By | 6 | SS == null && (CS == near && CSD <= 1 m) |
| | | && ! RS[Inside] && D >= 10 s |

* All states are relative to the respective place being calculated for. For example ! RS[Inside] would be read as “Recent States do not show the device was ‘inside’ the current place but may have been inside another place.”
**Formula variables may adjust to adapt to locations etc, for example SS level may change to adjust for AP position within the place, D may change to allow for variances in noise reduction etc.
*** Several samples may be taken for SS before calculations actually take place. Calculations may run many times based off of fluctuations in SS to allow for stabilization before state change is signaled.
**** Formula's for state changes above do not take into account noise reduction through data filtering which may or may not happen prior to calculations.

TABLE 2
(key to TABLE 1 above)

| | |
|---|---|
| SS | Signal Strength |
| CS | Current State |
| CSD | Current State Duration (how long we have been in the current |
| | state) |
| RS | Recent States (any of the recent states) |
| D | Duration or elapsed time over several samples during that time |
| ms | milliseconds |
| s | seconds |
| m | minutes |
| h | hours |
| && | and |
| \|\| | or |
| ! | not |
| == | equals |
| != | not equals |
| [ ] | contains, for example a contains b would read a[b] |
| null | none, non existent |

States may also contain additional sub-states that are calculated based off of similar information however offer additional information. These sub-states can be defined, but are not limited to, the following:

TABLE 3

| Sub State | Figure | Formula |
|---|---|---|
| Returned | 7 | (RS[Inside] \|\| RS[Near]) && D > 2 m && D < 1 h |
| | | && (CS == Inside \|\| CS == Near) |
| Duration | | D |

With the foregoing in mind, it should be repeated, that the location of a store Sᵢ and place state are not the same. Location is the determination of which store Sᵢ the device is physically located at as based on the APᵢ. The MAC addresses that correspond to a store and other data related to that store are stored remotely in the stationary application. Thus, the initial determination of the store's location may happens in the stationary application. However, as mentioned above, devices may pre-fetch this information ahead of time in order to decrease network load and decrease device battery use. With this in mind, devices will first look to their local cache of pre-fetched MACs (in the mobile application) to determine if there is a need to contact the stationary application. Although a mobile application may have the pre-registered MAC within its internal cache or data store, the mobile application may still contact the stationary application to update the MAC and/or other data associated to the store, if necessary.

Location (or place state) is the determination of the physical state of the device in correspondence to the store Sᵢ. This calculation may be handled on the device itself with no need to contact the stationary application. These calculations may change from time to time to further refine the accuracy in the algorithms used and may adapt based on the store they are associated to. For example, the AP_{A} located at store A may reside in the back of the store and thus the parameters to determine physical “entry” inside of the store may differ from those where the AP_{A} resides near the front of the store.

In yet another enhancement, the system may be adapted to recognize behavioral patterns (or behavioral state) of the user of the mobile device. For example, the behavioral state may indicate a habit of the user, for example, sleep time, wake-up time, breakfast time, lunch time, dinner time, etc, and/or a preference, for example, the user likes a certain type of car, clothing, accessories. In the behavioral states the place state (mentioned above) may be correlated with a clock time. Clock time may refer to the time shown on a clock. Examples of such behavioral states are illustrated in TABLE 4:

TABLE 4

| State | Formula |
|---|---|
| Sleep | Typical last use of device where non usage >4 h and |
| | typically during night hours |
| Wake Up | Typical first use of device where last use was >4 h |
| | and typically during morning hours |
| Interest | User interest as based on previous searches, websites |
| | visited, and apps installed. |
| Lunch | Based on time of frequent change in location during |
| | what would typically be lunch hours and offset from |
| | the Wake Up state time to adjust for night shift |
| | workers etc. |
| Dinner | Based on time of frequent change in location during |
| | what would typically be dinner hours and offset from |
| | Lunch state time. |
| Application | When a user installs a specific application on their |
| Installed | device. |

In each of the foregoing behavioral states, with the exception of the Application Installed, correlation with clock time may be valuable. In the behavioral state, Application Installed, correlation with clock time may not be necessary. Instead, Application Installed may be used as an indicator of a preference. The preferences could be used to modify actions (discussed below). However, the Application Installed behavioral state may be correlated with clock time, so that it may be determined how recently this preference this interest developed in the user.

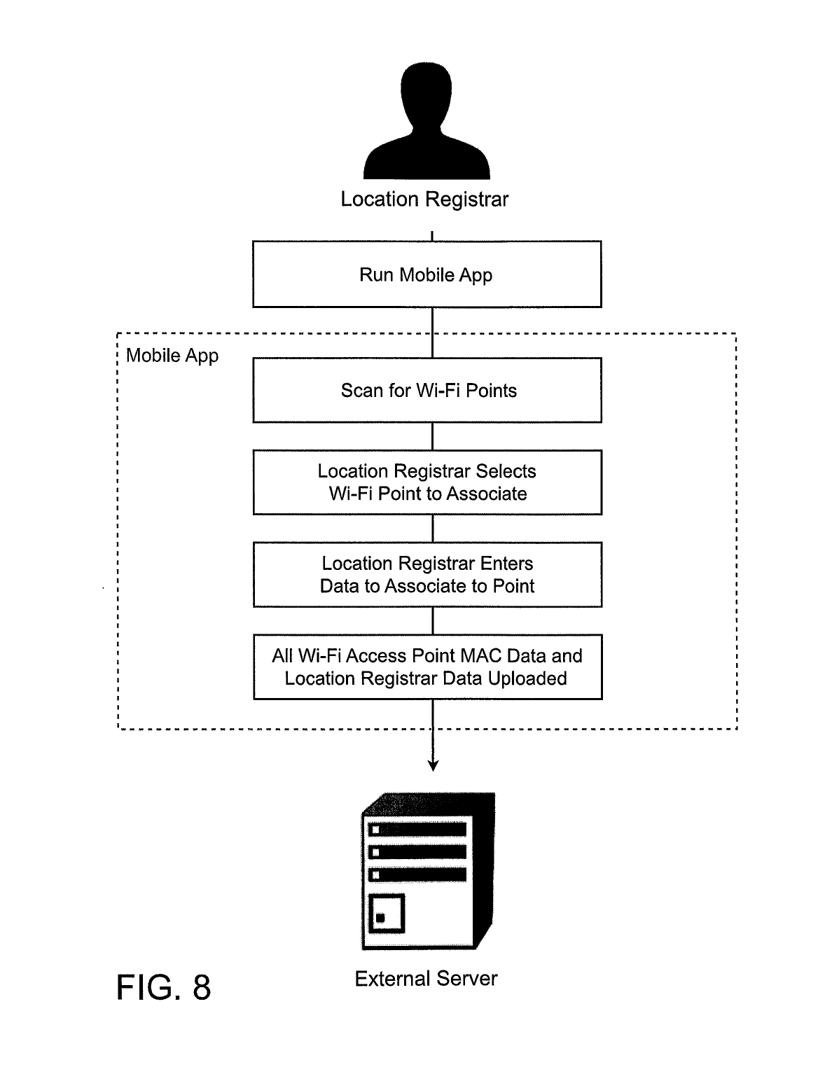

Referring to FIG. 8, the pre-existing list of MAC addresses will be illustrated. MAC address may refer to the MACᵢ address of the APᵢ for store Sᵢ, but may also include additional data relevant to store Sᵢ. Not all of that additional data may be necessary for the comparison used to determine the proximity (or location) of the mobile device to the store Sᵢ, but is available, if necessary.

MACᵢ information may be obtained one of many ways. One way to ensure near 100% accuracy is for store Sᵢ registrar (e.g., merchant, store owner, restaurateur, advertiser, etc.) to submit the MACᵢ information to the stationary application. Obtaining this information may be done one of many ways which may include:
1. Using a mobile application that collects relevant APᵢ information (including MACᵢ information) for all nearby APᵢ's to include the relevant one for the store itself. Through said mobile application the registrar (e.g., merchant, store owner, restaurateur, advertiser, etc.) would be able to enter any additional information about the store to include but not limited to the physical address, operation hours etc.
2. Through a website and web browser that collects the APᵢ information (including MACᵢ information) for all nearby APᵢ points to include the one for the store itself. Through said website the registrar (e.g., merchant, store owner, restaurateur, advertiser, etc.) would be able to enter any additional information about the store to include but not limited to the physical address, operation hours etc. Access to this information is typically restricted through normal means within a web browser thus until this restriction is removed other conventional methods could be used to add this capability such as browser plug-ins etc.
3. Through a website and web browser where the registrar (e.g., merchant, store owner, restaurateur, advertiser, etc.) could enter their relevant APᵢ (including MACᵢ information) information by hand to include all necessary registered data.

This pre-registered information is necessary for the determination of the physical location of the store. This information may be obtained through automated processes in software, however it may not necessarily be as reliable and therefore should be marked on the external server as such. Such marking could be a “verified” field in which the store location would not be verified but still usable. Another such marking could be a field “obtainedBy” or “method” which would store the method in which the pre-registered MACᵢ address was obtained and thus different actions could be taken based on this particular field.

The automated process of obtaining pre-registered MACᵢ would be through the inclusion of the software and libraries built into the mobile application. The software would be resident in the background and wait for the device to notify that an accurate GPS location is available for those devices with GPS enabled. Once accurate GPS data is available the software would then look for available APᵢ and their signal strength. This information would then be collected and sent to the external server. The server would then associate the available APᵢ's with the exact Latitude/Longitude coordinates for an exact geographic location of those APᵢ's. The pre-registered data in this manner does not necessarily produce the same location data as the previous manual methods. The system may then use at its discretion, a 3rd party database to help pull in other pre-registered data that may be associated to the APᵢ's in question.

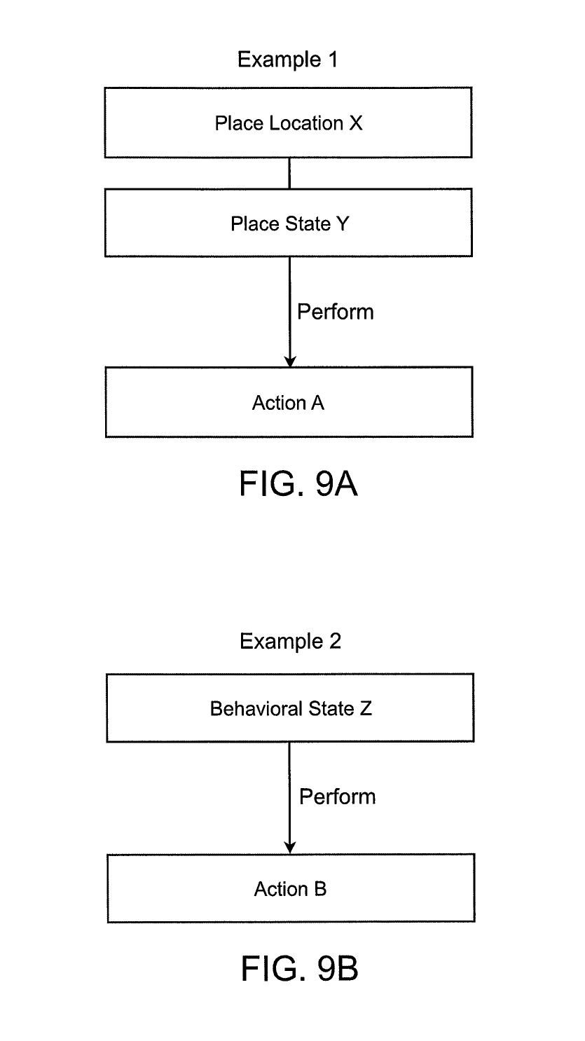

Referring to FIGS. 9-11, sending of the message (or advertisement) is illustrated. Message or advertisement are used interchangeably and are used to illustrate any type of information that may be sent to the user of the mobile device in response to the location, place state, and/or behavioral state determined by the system (or method). The message (or advertisement) may be any information that the advertiser (and/or merchant and/or store) may deem appropriate, including discount coupons, notification of sales, promotions, and/or rewards. This message may be generated in the stationary application, or the mobile application, or either. In one embodiment, the message is generated in the stationary application based upon information determined by the mobile application.

In FIGS. 9A and 9B, a simple messages are illustrated. Simple action data (or message or advertisement) is data that is associated to a specific State (e.g., location, place state, and/or behavioral state). This data associates to an action (e.g., send the message or advertisement) to perform based on the state which can be any kind of state. For example, in FIG. 9A (Example 1), when a device is at location X and has Place State Y perform action A. In FIG. 9B (Example 2), if the device has Behavioral State Z then perform Action B.

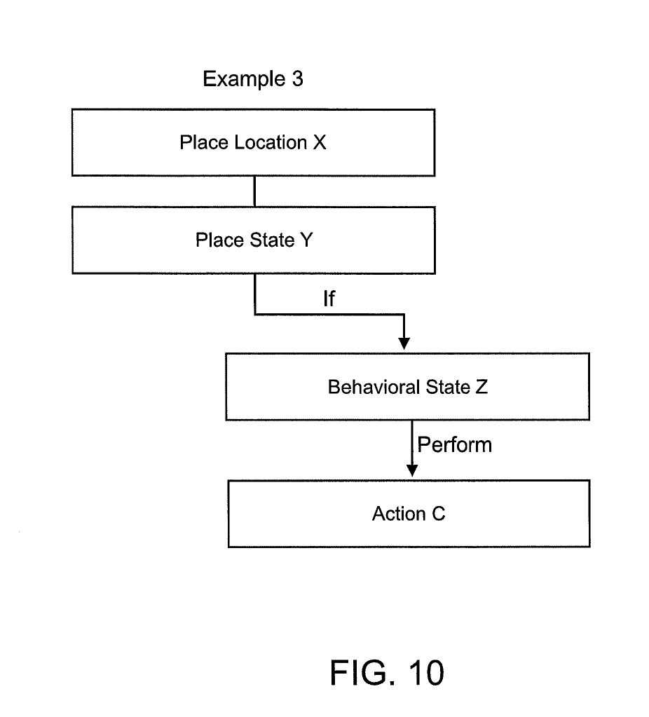

In FIG. 10, a more complex action is illustrated. Complex action data is simply a combination of simple action data or States acted upon as “triggers” in an if-then-if statement. In Example 3, if a device is at location X and the place state is Y, then if behavioral state is Z, then perform action C. Complex action data may be as simple as one state (e.g., location, place state, and/or behavioral state) to as complex as 100 states (e.g., location, place state, and/or behavioral state). It is notable that each state in the chain may not be triggered without all states prior to it being triggered first; hence, the states in a complex action set are called triggers.

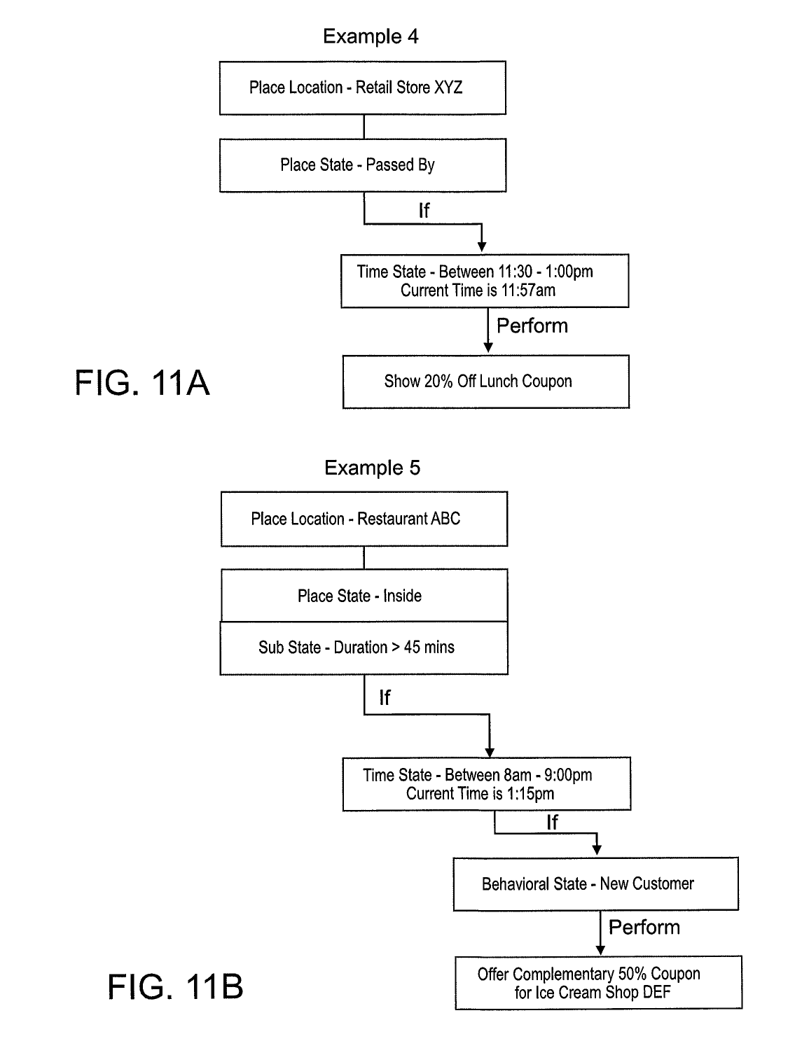

In FIGS. 11A and 11B, two real world examples are presented. In FIG. 11A, the flow chart may be followed as:

1) IF (trigger)
a) the device determines its place location to be retail store XYZ, AND
b) the necessary parameters have happened to fulfill the algorithm showing the device has a place state of “Passed By;”

2) THEN IF (trigger)
a) current local time (clock time) is 11:57 am which fulfills the set time state of between 11:30 am to 1:00 pm;

3) THEN (action)
a) perform the action of showing a 20% off lunch coupon advertisement to the customer.
   In other words, if the device passes by retail store XYZ and the time is between 11:30-1:00 pm, then show a 20% off lunch coupon to entice the customer to come back into the store.

In FIG. 11B, the flow chart may be followed as:

1) IF (trigger)
a) device is determined its place location to be restaurant ABC, AND
b) the necessary parameters have happened to fulfill the algorithm showing the device has a place state of “Inside,” AND
c) the place state of “Inside” has a sub-state showing a duration of at least 45 minutes (machine time);

2) THEN IF (trigger)
a) current time of 1:15 pm (clock time) is between the time state hours of 8 am-9 pm;

3) THEN IF (trigger)
a) the behavioral state shows “New Customer” for the place registrar of “Ice Cream Shop DEF”

4) THEN (Action)
a) perform the action of showing a 50% off coupon for Ice Cream Shop DEF
   In other words, if the device has been inside restaurant ABC for at least 45 minutes and the current local time is between 8 am and 9 pm and the customer has never been to Ice Cream Shop DEF then offer a 50% off coupon for Ice Cream Shop DEF.

The present invention may be embodied in other forms without departing from the spirit and the essential attributes thereof, and, accordingly, reference should be made to the appended claims, rather than to the foregoing specification, as indicating the scope of the invention.

I claim:

1. A system for sending an advertisement to a mobile communication device, across a wireless communication system, as the device passes close to or in to an advertiser having a wireless access point (AP) with a media access control (MAC) address comprises:
a mobile application residing on the mobile communication device, and
a stationary application located remotely from the mobile application,
the mobile application and the stationary application being in communication via the wireless communication system,
wherein the mobile application captures the MAC address of the advertiser's AP, the captured MAC address is compared to a pre-existing list of MAC addresses,
if there is a no match, then no advertisement is sent to the mobile application, but
if there is a match, then the advertisement is sent to the mobile application where the advertisement is displayed.

2. The system according to claim 1 wherein the pre-existing list of MAC addresses resides in the mobile application, or in the stationary application, or both.

3. The system according to claim 1 wherein the captured MAC address is first compared to a pre-existing list of MAC addresses in the mobile application, and, if necessary, is second compared to a pre-existing list of MAC addresses in the stationary application.

4. The system according to claim 1 wherein capturing the MAC address of the advertiser's AP further comprises:
mapping a proximity of the mobile communication device to the advertiser's AP as a function of a machine time.

5. The system according to claim 4 wherein the proximity of the mobile communication device to the advertiser's AP is determined by signal strength.

6. The system according to claim 4 wherein the mapped proximity as the function of the machine time is correlated to a clock time.

7. The system according to claim 4 wherein the advertisement sent to the mobile communication device is based on the mapped proximity as the function of time.

8. The system according to claim 6 wherein the advertisement sent to the mobile communication device is based on the mapped proximity as the function of time correlated to the clock time.

9. The system according to claim 1 wherein the advertisement sent to the mobile communications device is sent from the stationary application.

10. A method for sending an advertisement to a mobile communication device, across a wireless communication system, as the device passes close to or in to an advertiser having a wireless access point (AP) with a media access control (MAC) address comprises the steps of:
providing a mobile application residing on the mobile communication device, and
providing a stationary application located remotely from the mobile application,
communicating between the mobile application and the stationary application via the wireless communication system,
capturing the MAC address of the advertiser's AP in the mobile application,
comparing the captured MAC address to a pre-existing list of MAC addresses,
determining
if there is a no match, then no advertisement is sent to the mobile application, but
if there is a match, then the stationary application sends the advertisement to the mobile application where the advertisement is displayed.

11. The method according to claim 10 wherein the pre-existing list of MAC addresses resides in the mobile application, or in the stationary application, or both.

12. The method according to claim 10 wherein the captured MAC address is first compared to a pre-existing list of MAC addresses in the mobile application, and, if necessary, is second compared to a pre-existing list of MAC addresses in the stationary application.

13. The method according to claim 10 wherein capturing the MAC address of the advertiser's AP further comprises the step of:
mapping a proximity of the mobile communication device to the advertiser's AP as a function of a machine time.

14. The method according to claim 13 wherein the proximity of the mobile communication device to the advertiser's AP is determined by signal strength.

15. The method according to claim 13 wherein the mapped proximity as the function of the machine time is correlated to a clock time.

16. The method according to claim 13 wherein the advertisement sent to the mobile communication device is based on the mapped proximity as the function of time.

17. The method according to claim 15 wherein the advertisement sent to the mobile communication device is based on the mapped proximity as the function of time correlated to the clock time.

18. The method according to claim 10 wherein the advertisement sent to the mobile communications device is sent from the stationary application.
